(19) United States
(12) Patent Application Publication
(10) Pub. No.: US 2015/0001332 A1
(43) Pub. Date: Jan. 1, 2015

(54) Pet Waste Bag Kit

(71) Applicant: Jimmy Qin, S. El Monte, CA (US)

(72) Inventor: Jimmy Qin, S. El Monte, CA (US)

(21) Appl. No.: 13/931,924

(22) Filed: Jun. 29, 2013

(51) Int. Cl. A01K 23/00; B65H 16/00

(52) U.S. Cl. CPC A01K 23/005; B65H 16/005; B65H 2701/191
USPC 242/598.3

(57) ABSTRACT

A pet waste bag kit includes a dispenser receiving a pet waste bag roll, and a roll-back arrangement. The pet waste bag roll includes a plurality of continuous disposable bags stacked in a roll form, wherein a distal of a preceding disposable bag is linked to a proximal of a following disposable bag. When the preceding disposable bag is dispensed out of the dispenser through the slit opening, the proximal of the following disposable bag is pulled out of the dispenser through the slit opening. The roll-back arrangement is extended from a center of the pet waste bag roll for rolling back the continuous disposable bags in the dispenser to draw back the proximal of the following disposable bag toward the slit opening. The exposed portion of the proximal of the following disposable bag is minimized after the dispensing of the preceding disposable bag.

### BACKGROUND

1. Field of the Invention

The present invention relates to a pet waste bag. More particularly, the present invention relates to a pet waste bag kit in which the exposed portion of the proximal of the following disposable bag is minimized after the dispensing of the preceding disposable bag out of the dispenser.

2. Discussion of the Related Art

Many pet owners often “walk” their domestic pets, such as dogs, to give the animal exercise and to allow the pet to urinate and defecate in an outdoor location. Most pet owners have responsibility to retrieve and properly dispose of pet litter. A common method for collecting and storing pet litter is found by using a disposable plastic bag. However, the pet owner will always have to remember to grab a plastic bag prior to walking the pet. It is also a troublesome for the pet owner to carry the pet litter filled bag by one hand and leash the pet by the other hand.

Therefore, it can be appreciated that there exists a continuing need for new and improved devices for incorporating with the pet waste bag kit.

More importantly, there is a need for a pet wastes bag kit which can incorporate with or attach to a pet leash tool, such as a leash or a pet collar, to provide access to a roll of disposable bags when needed and to keep the roll of disposable bags clean and neat after dispensing of the disposable bag. The instant invention fulfills this need and provides other related advantages.

### BRIEF SUMMARY OF THE INVENTION

The present invention overcomes the above mentioned drawbacks and limitation by providing a pet waste bag kit, which is a simple, compact and inexpensive device.

The primary objective of the present invention is to have a pet waste bag kit, wherein the user, such as pet owner, is able to keep the roll of disposable bags clean and neat after dispensing of the disposable bag.

Another objective of the present invention is that the pet waste bag kit does not employ any complicated retractable mechanism to draw back the following disposable bag.

Another objective of the present invention is that the pet waste bag kit, wherein the exposed portion of the proximal of the following disposable bag is minimized after the dispensing of the preceding disposable bag out of the dispenser.

Another objective of the present invention is that the pet waste bag kit does not involve any expensive or complicated component.

Another objective of the present invention is that the existing disposable bag roll can be refilled into the dispenser of the pet waste bag kit.

Another objective of the present invention is that the pet waste bag kit is extremely light and portable, so that the user is able to carry the pet waste bag kit conveniently.

Another objective of the present invention is that the pet waste bag kit allows the user to save time and money to prepare waste bag prior to walking the pet.

Another objective of the present invention is that the pet waste bag kit is inexpensive in manufacturing cost.

The invention comprises the following, in whole or part:

a dispenser receiving a pet waste bag roll, and a roll-back arrangement.

The pet waste bag roll comprises a plurality of continuous disposable bags stacked in a roll form, wherein a distal of a preceding disposable bag is linked to a proximal of a following disposable bag. When the preceding disposable bag is dispensed out of the dispenser through a slit opening, the proximal of the following disposable bag is pulled out of the dispenser through the slit opening.

The roll-back arrangement is extended from a center of the pet waste bag roll for rolling back the continuous disposable bags in the dispenser to draw back the proximal of said following disposable bag toward the slit opening. As a result, the exposed portion of the proximal of the following disposable bag is minimized after the dispensing of the preceding disposable bag out of the dispenser.

The pet waste bag roll can be refilled into the dispenser.

The dispenser can be attached onto any existing leash tool, such as pet leash or pet collar.

The invention further provides a device for dispensing a pet waste bag roll. The device comprises a dispenser for receiving the pet waste bag roll with a plurality of continuous disposable bags stacked in a roll form. The dispenser has a slit opening for dispensing the pet waste bag roll out of the dispenser. The device further comprises a roll-back arrangement for coupling at a center of the pet waste bag roll to roll back the continuous disposable bags in the dispenser in order to draw back the proximal of the following disposable bag toward the slit opening.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a pet waste bag kit in accordance with a first embodiment of the instant invention.

FIG. 2 is a side view of the pet waste bag kit in accordance with the first embodiment of the instant invention.

FIG. 3 is a sectional view of the pet waste bag kit in accordance with the first embodiment of the instant invention.

FIG. 4 is a modification of the dispenser of the pet waste bag kit in accordance with the first embodiment of the instant invention.

FIG. 5 is a schematic view of the pet waste bag kit in accordance with a second embodiment of the instant invention as a modification of the first embodiment.

FIG. 6 is a sectional view of the pet waste bag kit in accordance with the second embodiment of the instant invention.

### DETAILED DESCRIPTION OF THE INVENTION

In accordance with an embodiment of the present invention, the present invention provides a pet waste bag kit to carry and dispense bags while walking the pet.

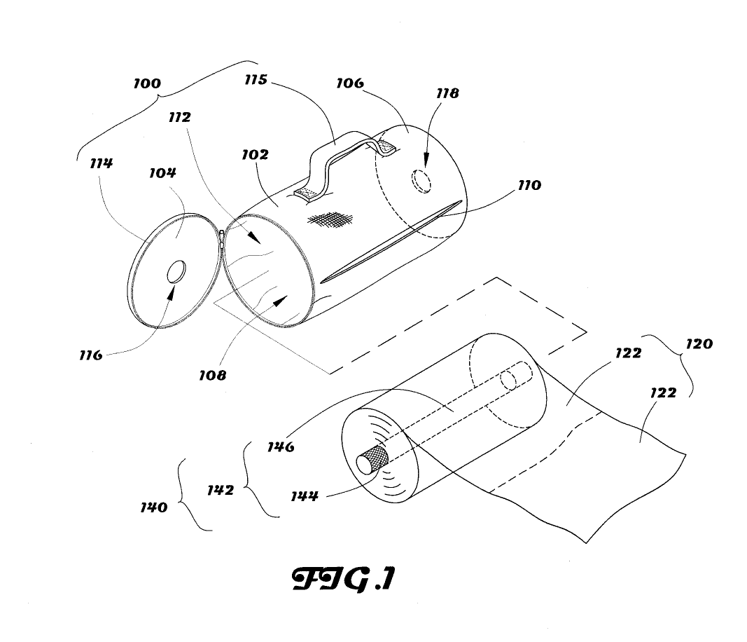

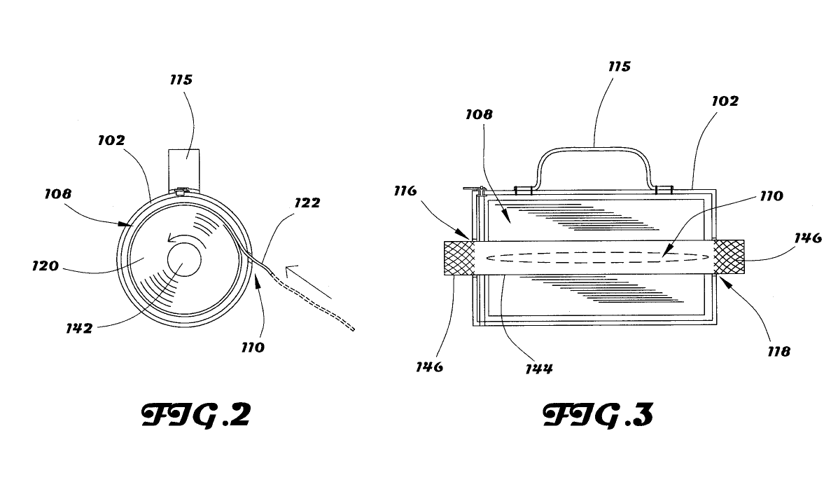

FIG. 1 to FIG. 3 depict a pet waste bag kit in accordance with a first embodiment of the instant invention. The pet waste bag kit comprises a dispenser 100, a pet waste bag roll 120, and a roll-back arrangement 140.

The dispenser 100 can be a soft case bag which is made of durable fabric such as nylon. It is preferred that the dispenser 100 has a waterproof inner lining. The dispenser 100 comprises a surrounding wall 102 and first and second sidewalls 104 and 106 forming a cavity 108 within the surrounding wall 102 and the sidewalls 104 and 106. In FIG. 1, the dispenser 100 has a circular cross section, wherein the surrounding wall 102 has a cylindrical shape and the sidewalls have a circular shape. The dispenser 100 further has an elongated slit opening 110 formed at the surrounding wall 102 between the sidewalls 104 and 106. The first sidewall 104 forms a cover of the dispenser 100, wherein a side opening 112 of the cavity 108 is formed at the side of the surrounding wall 102. The first sidewall 104 is detachably couple with the side opening 112 of the surrounding wall 102 to close the cavity 108. A fastener 114, such as a zipper, is provided at the side opening 112 to couple with the first sidewall 104 to detachably fasten the first sidewall 104 with the surrounding wall 102. A coupler 115 is also provided at the dispenser 100 for detachably coupling the dispenser 100 at a pet leash tool, such as a pet leash or a pet collar, in order to carry the dispenser 100 while walking the pet. The coupler 115 can be an eye loop or a hook to detachably couple with the pet leash tool, so that the user can carry the dispenser in a hand free manner. In this embodiment, the coupler 114 is formed at the outer side of the surrounding wall 102.

The pet waste bag roll 120 is received in the cavity 108 of the dispenser 100. The pet waste bag roll 120 can be disposed in the cavity 108 through the side opening 112 after the first sidewall 104 detached. The pet waste bag roll 120 comprises a plurality of continuous disposable bags 122 stacked in a roll form, wherein each of the disposable bags 122 is folded to have a predetermined folded width which is smaller than a distance between the sidewalls 104 and 106. It is preferred that each disposable bag 122 is tri-folded or quarterly folded to reduce the original width of the disposable bag 122.

A distal of the preceding disposable bag 122 is linked to a proximal of the following disposable bag 122. The continuous disposable bags 122 can be interconnected, wherein the preceding disposable bag 122 is attached to the proximal of the following disposable bag 122, wherein a perforation line is formed between the preceding disposable bag 122 and the proximal of the following disposable bag 122. Therefore, the preceding disposable bag 122 can be torn at the perforation line to detach from the following disposable bag 122. Or, the preceding disposable bag 122 is overlapped with the proximal of the following disposable bag 122 so that when the preceding disposable bag 122 is pulled out through the slit opening 110, the overlapped proximal of the following disposable bag 122 will then be pulled.

Each of the disposable bags 122 will be dispensed out of the dispenser 100 through the slit opening 110. When the preceding disposable bag 122 is dispensed out of the dispenser 110 through the slit opening 110, the pet waste bag roll 120 rotated in the cavity 108 in a dispensing direction. At the same time, the proximal of the following disposable bag 122 is also pulled out of the dispenser 100 through the slit opening 110. The proximal of the following disposable bag 122 forms the exposed portion of the disposable bag 122 out of the dispenser 100, so that the user can easily pull the exposed portion of the disposable bag 122 in order to dispense the disposable bags 122 one-by-one. However, an excessive length of the proximal of the following disposable bag 122 will be pulled out from the slit opening 110. Since the dispenser 100 is held at the pet leash tool, the proximal of the following disposable bag 122 will be contaminated when the pet urinates and/or defecates.

The roll-back arrangement 140 is extended from a center of the pet waste bag roll 120 for rolling back the continuous disposable bags 122 in the cavity 108 of the dispenser 100 in a retracting direction which is opposite to the dispensing direction. The proximal of the following disposable bag 122 is drawn back toward the slit opening 110. As a result, the exposed portion of the proximal of the following disposable bag 122 is minimized after the dispensing of the preceding disposable bag 122 out of the dispenser 100.

The roll-back arrangement 140 comprises a driving shaft 142 having an inner portion 144 coupled at the center of the pet waste bag roll 120 within the dispenser 100 and an outer portion 146 extended out of the dispenser 100. The outer portion 146 of the driving shaft 142 is arranged to be rotated manually to roll back the continuous disposable bags 122 in the dispenser 100.

The inner portion 144 of the driving shaft 142 extends at the center of the pet waste bag roll 120 and forms a central axle of the pet waste bag roll 120. Therefore, the disposable bags 122 are rolled around the inner portion 144 of the driving shaft 142. The driving shaft 142 is inherent with the pet waste bag roll 120. A length of the inner portion 144 of the driving shaft 142 matches with the folded width of the disposable bag 122. When the pet waste bag roll 120 is disposed in the cavity 108, the driving shaft 142 is located at the center of the cavity 108.

The outer portion 146 is integrated with and extended from inner portion 144 of the driving shaft 142 so that the driving shaft 142 forms an elongated rod structure. The outer portion 146 of the driving shaft 142 is protruded out of the dispenser 100. It is preferred that the outer portion 146 of the driving shaft 142 is protruded out of the sidewall 104, i.e. the cover, of the dispenser 100. When the disposable bag 122 is pulled and dispensed out of the dispenser 100, the driving shaft 142 will be driven to rotate in the dispensing direction. When the outer portion 146 of the driving shaft 142 is rotated in the retracting direction, the disposable bags 122 are rotated in the retracting direction within the cavity 108 and the exposed portion of the disposable bag 122 is drawn back. The outer portion 146 of the driving shaft 142 is shorter than the inner portion 144 thereof. The size of the outer portion 146 of the driving shaft 142 is big enough for the user to actuate by the fingers of the user. The outer portion 146 of the driving shaft 142 has an outer coarse surface so that the user is able to rotate the outer portion 146 of the driving shaft 142 easily.

The dispenser 100 further has a center through aperture 116 formed at the first sidewall 104, i.e. the cover of the dispenser 100. The outer portion 146 of the driving shaft 142 passes through the center through aperture 116 of the first sidewall 104. Therefore, when closing the cavity 108 by the first sidewall 104, the outer portion 146 of the driving shaft 142 will pass through the center through aperture 116 and will extend out of the dispenser 100.

It should be appreciated that by increasing the length of the driving shaft 142, two outer portions 146 are formed at two end portions of the driving shaft 142. The inner portion 144 of the driving shaft 142 will be formed between the two outer portions 146. A second center through aperture 118 is formed at the second sidewall 106 and is coaxial with the center through aperture 116 at the first sidewall 104. When the pet waste bag roll 120 is disposed in the cavity 108, the two outer portions 146 of the driving shaft 142 pass through the two center through apertures 116 and 118 and extend out of the dispenser 100 in opposite directions. This structure will ensure the pet waste bag roll 120 to be evenly support in the cavity 108 between the sidewalls 104 and 106, and will enhance the smooth rotational movement of the pet waste bag roll 120 in the cavity 108.

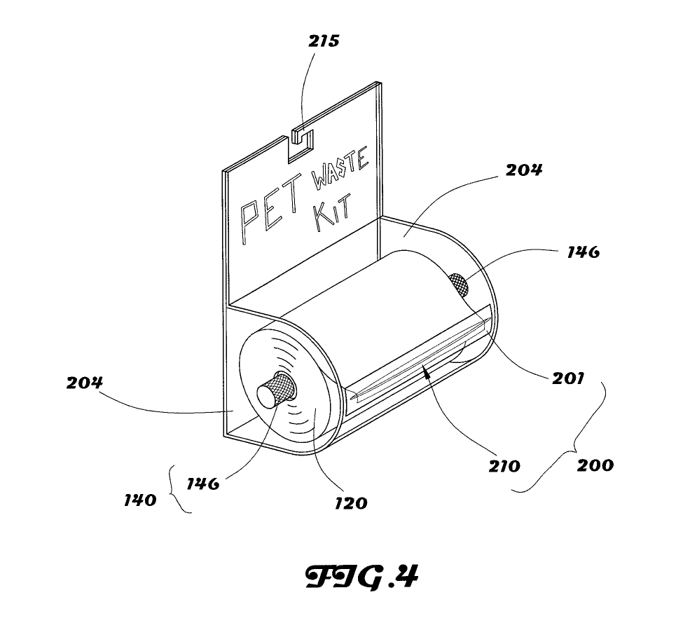

FIG. 4 depicts a modification of the dispenser of the pet waste bag kit, which has the similar structure and operation of the dispenser 100. The dispenser 200 is made of packaging material, such as plastic. The dispenser 200 is a packaging dispenser wherein the pet waste bag roll 120 and the roll-back arrangement 140 are packed or pre-installed into the dispenser 200 to form a ready-to-use kit. Therefore, the pet waste bag roll 120 and the roll-back arrangement 140 are permanently disposed in the dispenser 200 during the manufacturing process of the pet waste bag kit. The outer portion 146 of the driving shaft 142 is protruded out of the dispenser 100. It is preferred that the outer portions 146 of the roll-back arrangement 140 are protruded out of the sidewalls 204. The dispenser 200 is a disposable dispenser so that when the disposable bags 122 are used up, the dispenser 200 and the roll-back arrangement 140 will be disposed at the same time. The dispenser 200 also is a display dispenser having a hanger to be displayed and sold in the pet store or supermarket. The hanger of the hanger of the dispenser will be the coupler 215. Also, a sealing layer 201 is sealed at the slit opening 210 of the dispenser 200. The user is able to purchase the pet waste bag kit from any store and directly use the pet waste bag kit by simply peeling off the sealing layer 201.

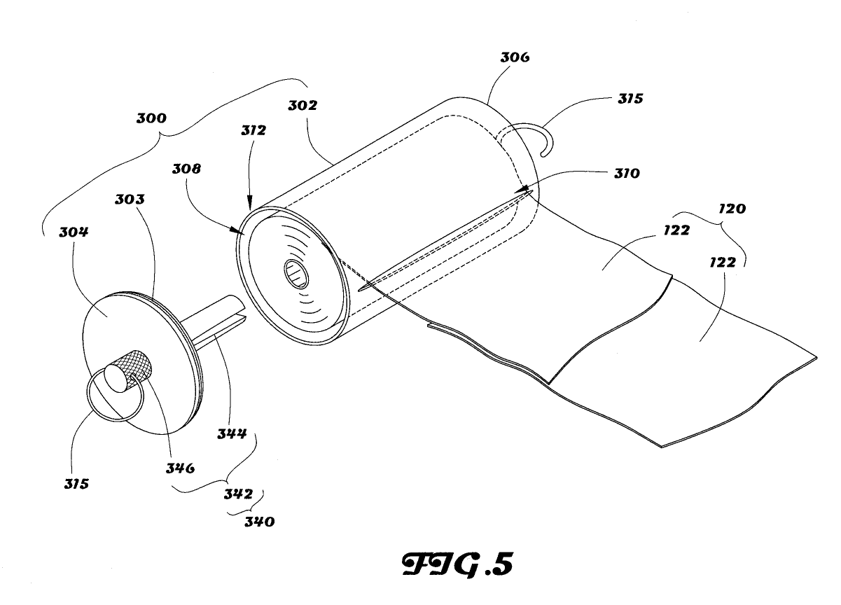

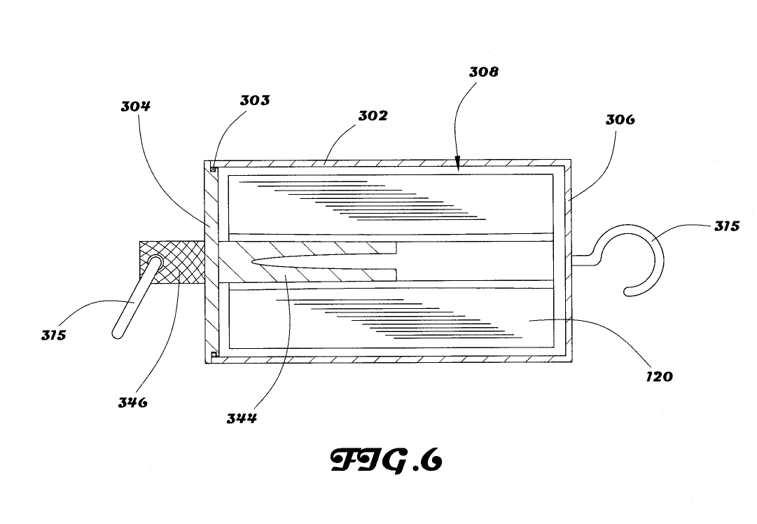

FIG. 5 and FIG. 6 depict the modification of the pet waste bag kit which has similar structure of the first embodiment. The dispenser 300 can be a rigid hard case bag which is made of durable material such as plastic. The dispenser 300 comprises a surrounding wall 302 and first and second sidewalls 304 and 306 forming a cavity 308 within the surrounding wall 302 and the sidewalls 304 and 306. The dispenser 300 further has an elongated slit opening 310 formed at the surrounding wall 302 between the sidewalls 304 and 306. The first sidewall 304 forms a cover of the dispenser 300, wherein a side opening 312 of the cavity 308 is formed at the side of the surrounding wall 302. The first sidewall 304 is detachably couple with the side opening 312 of the surrounding wall 302 to close the cavity 308. A coupler 315 is also provided at the dispenser 300 for detachably coupling the dispenser 300 at a pet leash tool, such as a pet leash or a pet collar, in order to carry the dispenser 300 while walking the pet. The dispenser further comprises a friction ring 303 encircling around a periphery of the first sidewall 304, i.e. the cover, to frictionally engage with the side opening 312 of the dispenser 300.

The roll-back arrangement 340 is extended from a center of the pet waste bag roll 120 for rolling back the continuous disposable bags 122 in the cavity 308 of the dispenser 300. The roll-back arrangement 340 comprises a driving shaft 342 having an inner portion 344 coupled at the center of the pet waste bag roll 320 within the dispenser 300 and an outer portion 346 extended out of the dispenser 300. The outer portion 346 of the driving shaft 342 is arranged to be rotated manually to roll back the continuous disposable bags 122 in the dispenser 300. The coupler 315 can also provide at the outer portion 346 of the driving shaft 342.

In this embodiment, the outer portion 346 and the inner portion 344 of the driving shaft 342 coaxial aligned with each other. The outer portion 346 and the inner portion 344 of the driving shaft 342 are extended from a center of the first sidewall 304. The outer portion 346 of the driving shaft 342 is integrated with and extended from an outer side of the first sidewall 304 whereas the inner portion 344 of the driving shaft 342 is integrated with and extended from an inner side of the first sidewall 304. The outer portion 346 of the driving shaft 342 has an outer coarse surface so that the user is able to rotate the outer portion 346 of the driving shaft 342 easily.

The inner portion 344 of the driving shaft 342 extends at the center of the pet waste bag roll 120 and can partially form a central axle of the pet waste bag roll 120. A length of the inner portion 344 of the driving shaft 342 can be shorter than the folded width of the disposable bag 122. When the pet waste bag roll 120 is disposed in the cavity 108, the driving shaft 342 is located at the center of the cavity 308. The inner portion 344 of the driving shaft 342 forms with a plurality of elastic arms spacing apart with each other. When the inner portion 344 of the driving shaft 342 is slid and inserted into the center of the pet waste bag roll 120, the elastic arms will be pressed to fit in the center of the pet waste bag roll 120. The outward elastic force at each elastic arm will tightly engage at the center of the pet waste bag roll 120. When the inner portion 344 of the driving shaft 342 is slid and inserted into the center of the pet waste bag roll 120, the first sidewall 304 will also be pushed to cover at the side opening 312 of the dispenser 300. Once the first sidewall 304 covers at the side opening 312, the inner portion 344 of the driving shaft 342 will be inserted into the center of the pet waste bag roll 120.

When the disposable bag 122 is pulled and dispensed out of the dispenser 300, the driving shaft 342 will be driven to rotate in the dispensing direction. At the same time, the driving shaft 322 as well as the first sidewall 304 will be rotated in the dispensing direction. The friction ring 303 will provide a frictional force that strong enough to secure the first sidewall 304 at the side opening 312 of the dispenser 300 but weak enough to resist the rotational force of the pet waste bag roll 120 in the cavity 308. Therefore, the first sidewall 304 will be rotated when dispensing the disposable bag 122.

When the outer portion 346 of the driving shaft 342 is rotated in the retracting direction, the disposable bags 122 are rotated in the retracting direction within the cavity 308 and the exposed portion of the disposable bag 122 is drawn back. At the same time, the first sidewall 304 will also be rotated in the retracting direction. After the exposed portion of the disposable bag 122 is drawn back with a desired length, the frictional force of the friction ring 303 will stop the rotational movement of the first sidewall 304 until any external force is exerted thereat. Therefore, the frictional force of the friction ring 303 will also hold exposed portion of the disposable bag 122 with the desired length after it is drawn back.

In this embodiment, the dispenser 300 becomes a storage and dispensing device for storing and dispensing the pet waste bag roll 120. The user is able to refill any existing pet waste ball roll 120 in the dispenser 300.

While the embodiments and alternatives of the invention have been shown and described, it will be apparent to one skilled in the art that various other changes and modifications can be made without departing from the spirit and scope of the invention.

What is claimed is:

1. A pet waste bag kit, comprising a dispenser receiving a pet waste bag roll, and a roll-back arrangement, said dispenser having a slit opening, said pet waste bag roll comprising a plurality of continuous disposable bags stacked in a roll form, wherein a distal of a preceding disposable bag is linked to a proximal of a following disposable bag, wherein when said preceding disposable bag is dispensed out of said dispenser through said slit opening, said proximal of said following disposable bag is pulled out of said dispenser through said slit opening, said roll-back arrangement extended from a center of said pet waste bag roll for rolling back said continuous disposable bags in said dispenser to draw back said proximal of said following disposable bag toward said slit opening.

2. The pet waste bag kit in claim 1 wherein said roll-back arrangement comprises a driving shaft having an inner portion coupled at the center of said pet waste bag roll within said dispenser and an outer portion extended out of said dispenser, said outer portion of said driving shaft being rotated to roll back said continuous disposable bags in said dispenser.

3. The pet waste bag kit in claim 2 wherein said dispenser comprises two sidewalls and a surrounding wall forming a cavity to receive said pet waste bag roll, said slit opening being formed at said surrounding wall between said sidewalls, said outer portion of said driving shaft extended out of one of said sidewalls.

4. The pet waste bag kit in claim 3 wherein said outer portion of said driving shaft has an outer coarse surface.

5. The pet waste bag kit in claim 4 wherein said inner portion of said driving shaft forms a central axle of said pet waste bag roll.

6. The pet waste bag kit in claim 5 wherein one of said sidewalls forms a cover of said dispenser to detachably couple with a side opening of said surrounding wall, said cover having a center through aperture, said outer portion of said driving shaft passing through said center through aperture of said cover.

7. The pet waste bag kit in claim 4 wherein one of said sidewalls forms a cover of said dispenser to detachably and rotatably couple with a side opening of said surrounding wall, said outer portion and said inner portion of said driving shaft coaxial aligned with each other and extended at an outer side and an inner side of a center of said cover.

8. The pet waste bag kit in claim 7 wherein said dispenser further comprises a friction ring encircling around a periphery of said cover to frictionally engage with said side opening of said dispenser.

9. The pet waste bag kit in claim 5 wherein said preceding disposable bag is attached to said proximal of said following disposable bag, wherein a perforation line is formed between said preceding disposable bag and said proximal of said following disposable bag.

10. The pet waste bag kit in claim 8 wherein said preceding disposable bag is attached to said proximal of said following disposable bag, wherein a perforation line is formed between said preceding disposable bag and said proximal of said following disposable bag.

11. The pet waste bag kit in claim 5 wherein said preceding disposable bag is overlapped with said proximal of said following disposable bag.

12. The pet waste bag kit in claim 8 wherein said preceding disposable bag is overlapped with said proximal of said following disposable bag.

13. A device for dispensing a pet waste bag roll, comprising a dispenser for receiving said pet waste bag roll with a plurality of continuous disposable bags stacked in a roll form, and a roll-back arrangement, said dispenser having a slit opening for dispensing a preceding disposable bag of said pet waste bag roll out of said dispenser, said roll-back arrangement for coupling at a center of said pet waste bag roll to roll back said continuous disposable bags in said dispenser in order to draw back said proximal of said following disposable bag toward said slit opening.

14. The device in claim 13 wherein said roll-back arrangement comprises a driving shaft having an inner portion for coupling at the center of said pet waste bag roll within said dispenser and an outer portion extended out of said dispenser, said outer portion of said driving shaft being rotated for rolling back said continuous disposable bags in said dispenser.

15. The device in claim 14 wherein said dispenser comprises two sidewalls and a surrounding wall forming a cavity for receiving said pet waste bag roll, said slit opening being formed at said surrounding wall between said sidewalls, said outer portion of said driving shaft extended out of one of said sidewalls.

16. The device in claim 15 wherein said outer portion of said driving shaft has an outer coarse surface.

17. The device in claim 16 wherein one of said sidewalls forms a cover of said dispenser to detachably and rotatably couple with a side opening of said surrounding wall, said outer portion and said inner portion of said driving shaft coaxial aligned with each other and extended at an outer side and an inner side of a center of said cover.

18. The device in claim 17 wherein said inner portion of said driving shaft passes through the center of said pet waste bag roll and forms a central axle of said pet waste bag roll.

19. The device in claim 17 wherein said dispenser further comprises a friction ring encircling around a periphery of said cover to frictionally engage with said side opening of said dispenser.

20. The device in claim 17 further comprising means for detachably coupling said dispenser at a pet leash tool.
